(19) United States
(12) Patent Application Publication
(10) Pub. No.: US 2019/0183134 A1
(43) Pub. Date: Jun. 20, 2019

(54) SYSTEM AND METHOD FOR MONITORING UTENSILS IN SLAUGHTERHOUSES, AND UTENSIL

(71) Applicant: MUNDIAL S.A. PRODUTOS DE CONSUMO, São Paulo - SP (BR)

(72) Inventor: Wagner HUBER, Rubem Berta - RS (BR)

(21) Appl. No.: 16/329,932

(22) PCT Filed: Sep. 1, 2017
(86) PCT No.: PCT/BR2017/050256

§ 371 Date: Mar. 1, 2019

(30) Foreign Application Priority Data
Sep. 1, 2016 (BR) BR102016020293-0

(51) Int. Cl. A22B 5/00; A22B 3/10; B26B 11/00

(52) U.S. Cl. CPC A22B 5/00; B26D 5/30; B26B 11/008; A22B 3/10

(57) ABSTRACT

The present invention relates to a system for monitoring utensils (100) in slaughterhouses, comprising: at least one utensil (100) comprising at least one readable medium (110) identifying the at least one utensil (100); at least one reading device (210, 220, 230, 240, 250, 260, 270, 280) in at least one specific location of the slaughterhouse, reading the at least one readable medium (110) of at least one utensil (100) for collecting at least one data relative to said utensil (100); wherein the data collected by the reading device (210, 220, 230, 240, 250, 260, 270, 280) is stored in at least one of a hardware and a cloud database.

The present invention relates to a system and method for monitoring utensils in slaughterhouses, and utensils, wherein the utensils have a type of identification for monitoring, wherein specific data about said utensils is recorded in order to obtain traffic control and usage data of the utensils.

### DESCRIPTION OF THE PRIOR ART

The market for meat production is promising and durable, but working on a slaughterhouse is a risky activity. Slaughterhouse workers are often cut off due to work-related diseases (WMSD) and repetitive strain injuries (RSI). In addition, slaughterhouse workers have higher chances of trauma (including cuts with saws and knives) of the abdomen, shoulder and arm, four times more muscle and tendon inflammation, and up to seven times more wrist injuries due to ergonomic problems.

In order to change this scenario, many labor laws are created in order to address the usability aspects of knifes and tools with ergonomic aspects such as handle, comfort, weight, ease of use, analysis of movements and activities, as well as constant sharpening and control and replacement systems for sharp knives. Such focus, for example, on the sharpening of knives aims at eliminating a common practice in slaughterhouses: the provision of shortened knives to increase the useful life of these products, but with negative consequences in terms of long-term ergonomic problems for workers.

In order to comply the process of sharpening knives to labor laws, slaughterhouses need innovations in their registration and control systems for knife sharpening. In this sense, the possibility of important technological innovations arises.

An example of a system that makes this interconnection is in U.S. Pat. No. 6,867,598 that relates to a system for identification and tracking of utensils in slaughterhouses for deboning purposes. The system describes that the utensils can only be a knife or a glove, and their main purpose is to control prerequisites (primarily sanitizing) by mapping the locations and periods the knife passes and comparing with a previously established protocol. In addition, the document does not mention many types of data that can be collected and aim more the theft control of utensils.

WO2005108183 discloses a deboning or chopping knife, comprising a blade and a handle, wherein a transponder, comprising a information storing transceiver device and unit controller, is inserted into the knife handle. The document focuses on the knife communication via RFID with any reading device, storing the information on at least one computer in the slaughterhouse where the readings are being performed. In addition, the system allows recording of multiple information, including when sanitizing occurs and when sharpening occurs, but according to the document, the recording of data is not automatic and the invention aims only to control whether the operational requirements are being followed (previously defined protocol), that is to say, whether the knife is sharpened, if sanitization is performed, who is responsible for the knife, if there were no knife disappearing in the process, etc.

WO2009146681 discloses a method for detecting and/or identifying a hand tool. The document looks at aspects of user controls and responsibility for knife or other utensils, especially to prevent knife theft and sabotage (such as an employee purposely putting the knife in grinders, destroying machines or causing any damage to the slaughterhouse).

### OBJECTIVE OF THE INVENTION

It is an objective of the present invention to provide a system and method for monitoring utensils for slaughterhouses capable of including recording of utensil data shareable with the various slaughterhouse plants and the knife factory itself.

It is also an objective of the present invention to maintain the record data of the utensils in a cloud.

It is yet an objective of the present invention to collect satisfaction data from utensil users.

A further objective of the present invention is to be able to retain control data of workers movement and work in order to effectively prevent repetitive strain injuries and thus provide a form of control and monitoring for labor laws.

Another object of the present invention is to provide a system and method of integrating collected data from all the utensil data capture locations with the slaughterhouse and the utensil factory in order to create a data network.

It is a further an object of the present invention to provide a utensil with a readable medium that assists in monitoring it.

### BRIEF DESCRIPTION OF THE INVENTION

The objectives of the invention are achieved by means of a system for monitoring utensils in slaughterhouses, comprising: at least one utensil comprising at least one readable medium identifying the at least one utensil; at least one reading device, in at least one specific location of the slaughterhouse, reading the at least one readable medium of the at least one utensil for collecting at least one data relating to that utensil, wherein the data collected by the reading device is stored in at least one of a hardware and a cloud database.

The objectives of the invention are further achieved by a utensil comprising: at least one readable medium, which identifies the at least one utensil for monitoring in the system of the present invention, wherein preferably the at least one readable medium is a radiofrequency device which is inserted inside the utensil.

The objects of the invention are additionally achieved by a method for monitoring utensils in slaughterhouses using the system of the present invention, wherein the method comprises the steps of:

collecting at least one data referring to at least one utensil;

storing the data collected on at least one of a hardware and a cloud database; and

providing the data for query and monitoring of the at least one utensil.

### BRIEF DESCRIPTION OF THE DRAWINGS

The present invention will be described in more detail below, based on the figures. The figures show:

FIG. 1—is a floor plan of an exemplary embodiment of a slaughterhouse for deboning;

FIG. 2—is a perspective view of an embodiment of the disposal device;

FIG. 3—is a side cut of a preferred embodiment of a utensil; and

FIG. 4—is a block diagram of the steps of the method for monitoring utensils in slaughterhouses in an embodiment according to the present invention.

### DETAILED DESCRIPTION OF THE DRAWINGS

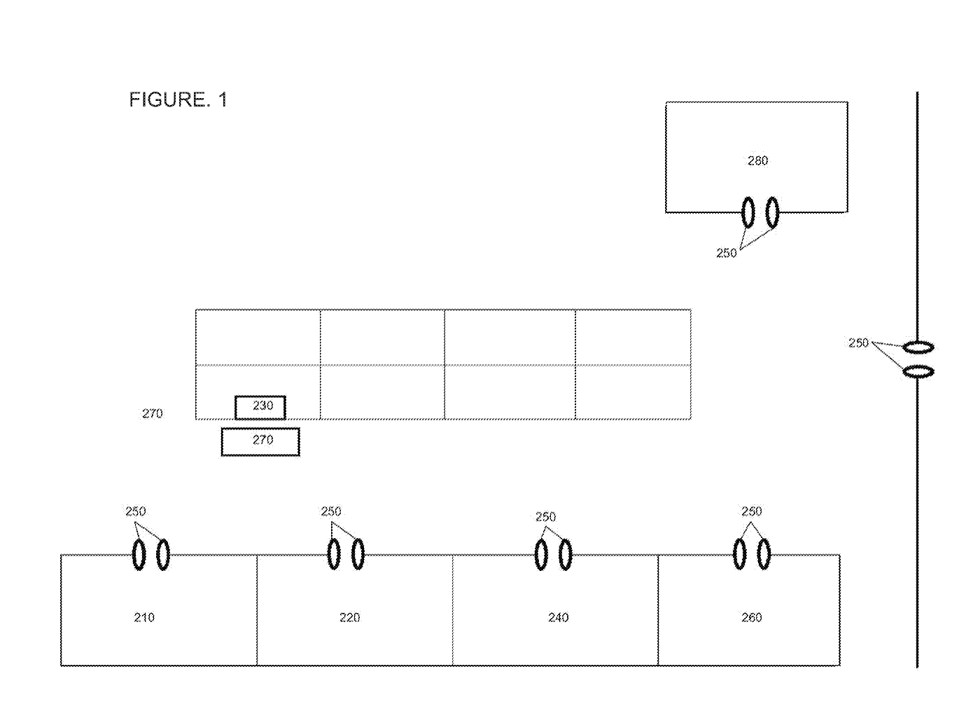

In FIG. 1, it is shown a floor plan embodiment of a slaughterhouse, in which the system of the present invention may be employed.

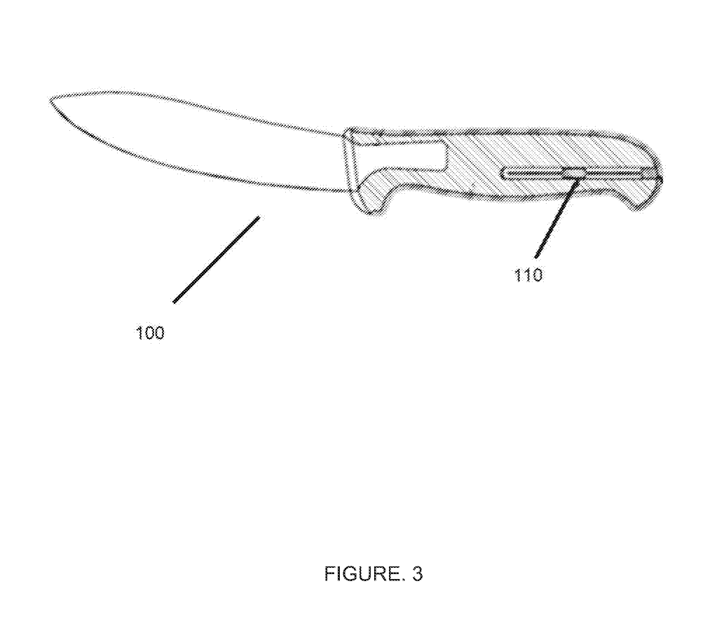

The system comprises at least one utensil 100, indicated in FIG. 3, which in turn, comprises at least one readable medium 110 which identifies the at least one utensil 100. The utensils 100 will be better described below.

The system further comprises at least one reading device 210, 220, 230, 240, 250, 260, 270, 280. The reading device 210, 220, 230, 240, 250, 260, 270, 280 reads the at least one readable medium 110 located on the at least one utensil 100 to collect at least one data relative to that utensil 100.

The at least one reading device 210, 220, 230, 240, 250, 260, 270, 280 is at least one of: a sharpening device 210, a sanitizing and sterilizing device 220, a chopping aid and support device 230, a disposal device 240, a passage warning device 250, a storage 260, a workstation device 270, and a blade realignment device 280.

The sharpening device 210 comprises sharpening means, which sharpens the utensil 100 and reading means that reads the at least one readable medium 110 while the utensil is within reach of the reading means. The sharpening device 210 is at least one of: a hand sharpener and an automatic sharpener, wherein the abrasive of the sharpeners can be made of different materials. The reading means of the sharpening device 210 may be located integrated in the devices themselves or in a movable device which is disposed in a suitable location near the sharpening devices. While the utensil 100 is sharpened, the reading means collects at least one of the data: utensil identification, start time and date of sharpening, end time and date of sharpening, time of sharpening, inclination angle of sharpening, pressure against the abrasive, type of abrasive, adjustment of the positions of the abrasive, number of sharpenings, sharpening evaluation, and other data calculated from the data initially collected. The sharpening device 210 may be located anywhere on the slaughterhouse floor.

The sanitizing and sterilizing device 220 comprises: sanitizing means, which sanitizes the utensil 100, sterilizing means, which sterilizes the utensil 100 and reading means that reads the at least one readable medium 110 while the utensil 100 is within the reach of the reading means. The sanitizing and sterilizing device reading means may be located integrated in the sanitizing and sterilizing device itself or in a movable device which is disposed in a suitable location near the sanitizing and sterilizing device so that while the utensil 100 is sanitized or sterilized, the reading means collects at least one of the data: identification of the utensil 100, sanitizing start time and date, sanitizing time, sanitizing temperature, sterilization start time and date, sterilization time and sterilization temperature. In an alternative embodiment of the invention, the sanitizing and sterilizing device 220 are two separate devices, one for sanitizing and one for sterilizing, wherein each device comprises its respective reading means and collects its respective data. The sanitizing and sterilizing device 220 may be located anywhere in the slaughterhouse plant.

The chopping aid and support device 230 comprises: cutting support means which minimizes the loss of sharpness of the utensil 100 when both come into contact and reading means that reads the at least one readable medium 110 while the utensil 100 is within reach of the reading means. The reading means of the chopping aid and support device 230 may be built-in the chopping aid and support device 230 itself or may be removable so that while the utensil 100 is used against the chopping aid and support device 230, the reading means collects at least one of the data: identification of the utensil 100, reading start time and date, pressure against the cutting board 230, number of times that the utensil 100 comes into contact with the chopping aid and support device 230, contact total time of utensil 100 with the chopping aid and support device 230 and position of utensil 100 while a user performs his task, wherein the position of utensil 100 assists in identifying the user function of the utensil 100 at that workstation. In an alternative embodiment of the invention, the reading means is located outside the cut aid and support device 230 in a movable device that is disposed in a suitable location near the chopping aid and support device 230 so that while the utensil 100 is used, the reading means collects at least one of the data: identification of the utensil 100, reading start time and date, and position of the utensil 100. The chopping aid and support device 230 is preferably located in a workstation, in which the user of the utensil 100 performs his task.

The workstation device 270 comprises reading means that reads the at least one readable medium 110 while the utensil 100 is within reach of the reading means, wherein the workstation device 270 is located at a location where the reading means of the workstation device 270 is effectively able to read the readable medium of the utensil 110 used in the workstation. Preferably, the workstation device is located on a surface below where the utensil 100 is used or suspended above where the utensil 100 is effectively used by a user to accomplish his task. The reading means of the workstation device 270 collects at least one of the data: identification of the utensil 100, reading start time and date, dwell time of utensil 100 at the workstation and position of utensil 100, wherein the position of the utensil 100 assists in identifying the function of a user of the utensil 100 at that workstation. The workstation device 270 may preferably be integrated with the deboning counter, in the form of a rug or as a device suspended over the user of the utensil 100. In addition, in a preferred embodiment of the invention, the workstation device 270 informs the user that the utensil needs at least one of a maintenance of: sharpening, sanitizing and blade realignment, when a certain time of the last maintenance has elapsed and the utensil needs maintenance.

The workstation is the place where a utensil user performs its function, wherein the function is any function that a utensil user can develop in a slaughterhouse. Preferably, the workstation is where the user performs the deboning of an animal or part thereof.

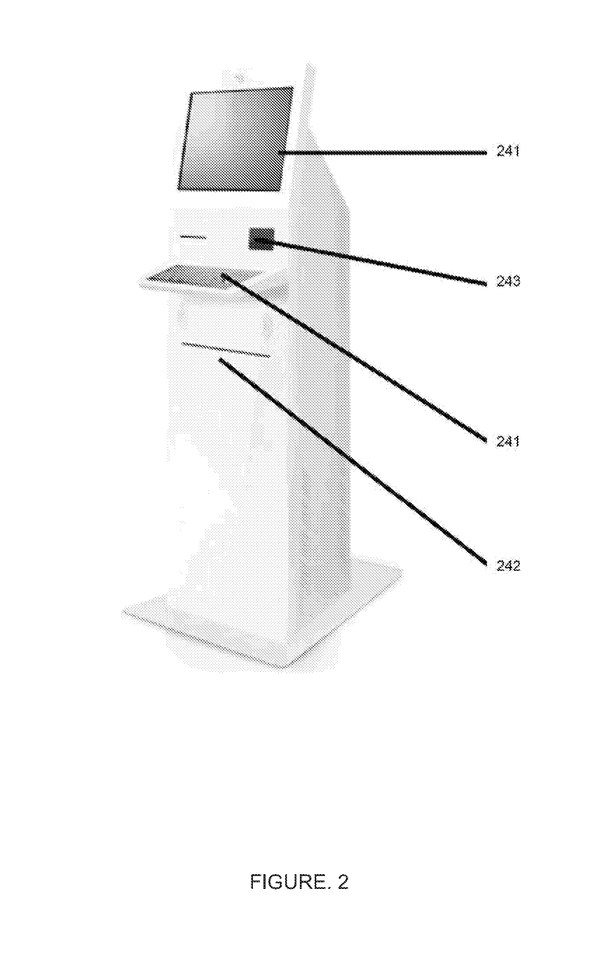

An example of an embodiment for the disposal device 240 is shown in FIG. 2. The disposal device 240 comprises: user communication means 241, utensil disposal means 242 and reading means 243, that reads the at least one readable medium 110 while the utensil 100 is within the reach of the reading means 243, in order for the utensil 100 to be discarded, the user must inform the reason through the means of communication 241, and if the disposal is approved, the disposal means 242 enables the disposal of the utensil 100 in which the disposal device 240 provides the user through user communication means (241): query of the history of use of the utensil, query of the amount of utensils discarded and listing of discarded utensils. The user communication means 241 is at least one of: a display, a keyboard, a mouse, a touch-sensitive device, wherein the display is preferably touch sensitive to the user and interprets the user's touch so that the disposal device 240 operates property. The reading means 243 of the disposal device 240 collects at least one of the data: identification of the utensil 100 and time and date of disposal. The user communication means 241 of the disposal device 240 enables the user to provide at least one of: utensil sharpening evaluation, reason for utensil disposal, user's admission dates in the slaughterhouse, and user's training dates.

In order for the user to discard the utensil 100, the user must provide the reason why that utensil 100 is being discarded. The disposal device 240 may have predefined disposal reasons or the user may enter the reason through the user communication means 241. The disposal device 240 should assess whether that utensil 100 can be discarded or not and thereby enable, through the disposal means 242, the disposal of that utensil 100. The disposal means 242 is preferably an opening in the disposal device 240, which should open for the user to insert the utensil 100 to be discarded.

The storage 260 comprises: a location suitable for storing the utensils 100 and reading means that reads the at least one readable medium 110 while the utensil 100 is within reach of the reading means. The storage reading means 260 collects at least one of the data: identification of the utensil 100, time and date of storage entry or exit. The storage 260 is at least one of a collective utensil 100 storage means or an appropriate place where the user should store his individual utensils 100. Every slaughterhouse has a different storage means for utensils. The storage means 260 may be collective or individual, thus the need for the present invention to adapt itself to every need of each slaughterhouse. The storage reading means 260 may be located at a suitable location where they are effectively stored or in the form of a passageway such as a window, whereby the utensils are returned for storage at the end of the working day.

The passage warning device 250 comprises: a warning device and reading means that reads the at least one readable medium 110 while the utensil 100 is within reach of the reading means, the warning device emits at least one of an audible alert and a visual alert, when the reading means identifies a utensil 100 which should not to be moved through the passage device 250. The passage warning reading means collects at least one of the data: identification of the utensil and time and date of passage of the utensil.

The passage warning device 250 may be located in any pass-through aperture in which a utensil 100 may pass. These apertures, which may be passage doors between the rooms of a slaughterhouse, utensil 100 delivery windows, windows of the slaughterhouse itself or entrances to the slaughterhouse. In one embodiment of the invention, the slaughterhouse has rooms for each reading device 210, 220, 230, 240, 250, 260, 270, 280 and for other purposes in general. The passage warning devices 250 are located in the pass-through apertures of the rooms, thereby controlling the flow of utensils 100 between the slaughter rooms.

The blade realignment device 280 comprises: blade realignment means and reading means that reads the at least one readable medium 110 while the utensil 100 is within the reach of the reading means. The blade realignment device 280 is at least one of: a manual blade realignment device and an automatic blade realignment device. In one embodiment, the realignment device 280 is fixed and automatic at a specific location in the slaughterhouse. The reading means of the blade realignment device 280 may be located integrated in the devices themselves or in a movable device which is disposed in a suitable location near the blade realignment devices so that while the utensil 100 is realigned, the reading means collects at least one of the data: utensil 100 identification, time and date of the realignment, number of times the utensil 100 was realigned and total realignment time.

In an alternative embodiment, the blade realignment device 280 is movable and has at least one readable medium 110 and is treated like any other utensil 100 by the reading devices 210, 220, 230, 240, 250, 260, 270, 280. In this embodiment, the user takes the realignment device 280 together to carry out his/her work.

The at least one reading device 210, 220, 230, 240, 250, 260, 270, 280 may also have means for inserting data. The user performs access for insertion of data through a login and password through the user communication means located in the reading device 210, 220, 230, 240, 250, 260, 270, 280.

The at least one utensil 100 is at least one of: a knife, preferably for deboning, a protective glove, a meat separation aid device, an apron, a cap, a blade realignment device, a retainer device for pieces of meat, a user identification bracelet, individual protective equipment, an individual storage device among other utensils that a worker from a slaughterhouse must carry in their day to day working in the slaughterhouse.

In one embodiment, the slaughterhouse must choose which utensils should comprise the at least one readable medium 110. The readable medium 110 will be read each time it passes a reading device 210, 220, 230, 240, 250, 260, 270, 280. The present invention encompasses that each individual utensil 100 of each user working in the slaughterhouse comprises the at least one readable medium 110.

In a further embodiment, all slaughterhouse utensils 100 comprise at least one readable medium 110 and the slaughterhouse selects which reading devices 210, 220, 230, 240, 250, 260, 270, 280 are to collect the data of the utensils 100.

The present invention comprises a combination of possibilities of readable medium in utensils 100, wherein if it is not of interesting to the slaughterhouse, a particular utensil will not comprise the readable medium. In addition, reading devices 210, 220, 230, 240, 250, 260, 270, 280 should also comprise given reading means for a given readable medium 110 and, if the slaughterhouse is interested, it should read the at least one readable medium of the given utensil 100.

The at least one readable medium 110 is at least one of: a bar code, a numerical code, a radio frequency device, a Bluetooth device, an infrared device and a QRCOD.

FIG. 3 shows a preferred embodiment of a utensil 100, object of the present invention, wherein the utensil 100 is a knife, preferably for deboning. In this preferred embodiment, the at least one readable medium 110 is a radiofrequency device that is inserted into the interior of the utensil 100.

In alternative embodiments, the at least one utensil 100 comprises more than one readable medium 110, preferably at least two of: a bar code, a radiofrequency device, a Bluetooth device and an infrared device. In such embodiments, each reading device 210, 220, 230, 240, 250, 260, 270, 280 may collect different data from different readable media 110.

In one example of the present invention, the utensil 100 comprises only one readable medium 110, the readable medium 110 preferably being a radiofrequency device. Each time the utensil 100 passes a reading distance of a reading device 210, 220, 230, 240, 250, 260, 270, 280, it will collect the data of the utensil 100.

In another example of the alternative embodiment of the present invention, the utensil 100 comprises a readable medium 110, preferably a radiofrequency device, and another readable medium such as, for example, a bar code. Each reading device 210, 220, 230, 240, 250, 260, 270, 280 will have its reading means suitable for at least one of the two readable medium 110. Thus, a sharpening device 210 may comprise reading means that collect data from the radio frequency device signal and reading means to read a bar code from the utensil 100 to collect different data from the reading means of the radio frequency device. In addition, in order to exemplify the different combinations of quantities and types of readable mediums 110 and reading devices 210, 220, 230, 240, 250, 260, 270, 280 which collect data from each of the readable mediums 110 types, the same example of the previous alternative embodiment, a sanitizing and sterilizing device 220 comprises only means for reading the radio frequency device, and can thus only collect data relating to that readable medium.

Each slaughterhouse should define which readable medium to use, where and which reading device should collect what data pertaining to which utensil, in the way that best suits the slaughterhouse.

Through the present invention, data collected from at least one reading device 210, 220, 230, 240, 250, 260, 270, 280 can be stored in one of: a hardware of each reading device 210, 220, 230, 240, 250, 260, 270, 280, a central hardware that is interconnected between each of the at least one reading device and directly into a cloud, wherein the data stored in the cloud can be sent directly through the reading devices 210, 220, 230, 240, 250, 260, 270, 280 or via a central sending device which receives data from at least one reading device 210, 220, 230, 240, 250, 260, 270, 280 and sends these data for cloud storage.

Through this system, the present invention is able to interact with all data collected in order to provide usability improvement for the user (operators), the slaughterhouse and the utensil factory. The present invention enables the interaction between the utensil 100 manufacturer with the slaughterhouse, the user, the activity and maintenance of the utensil (sharpening, sanitizing and any other activity performed on the utensil). As a result, the user evaluates the utensil and the data collected by the reading devices 210, 220, 230, 240, 250, 260, 270, 280.

Thus, all the data collected aim to identify the factors that affect the usability of the utensil 100, such as the human factor involved, the activity exerted, the environment of use of the utensil and the conditions of manufacture of the utensil 100. The usability result of the utensil is measured by satisfaction of the interaction of these factors, since it records the user's evaluation, that is, momentary satisfaction with the used utensil. The usability of the utensil 100 is always something subjective and momentary being influenced by the interaction of all the data collected by the present invention, sharpening data, sanitizing data, lifespan data, the timing and reason for disposal, and the design of the product itself suitable to the user and activity. Change in any variable may be significant in the final evaluation of the utensil.

Additionally, in one embodiment of the invention, some data is inserted into the system to better evaluate all of the usability variables of the utensils 100. The data may refer to the information of the slaughterhouse or utensil 100.

The data to be entered relating to the information of the slaughterhouse is at least one of: the gender of the user of the utensil 100, utility of the utensil 100, such as, for example, whether the utensil is being used for deboning or trim, the type of meat to be to be deboned, whether the utensil is used in a slaughter area or chopping area, i.e., against cold meat or hot meat, among others.

The data to be entered concerning the slaughterhouse information can be linked to the utensils by at least one of: the slaughterhouse itself, when it receives the utensils 100, the utensil factory and the user. The user or slaughterhouse can link the information when the utensil is first received. The user may also link this information at the beginning of his/her shift or when it reaches some reading device 210, 220, 230, 240, 250, 260, 270, 280, preferably the workstation 270.

The data linked to the utensil 100 are at least one of: blade design, steel type, handle type, user-performed activity. Such data linked to the utensil 100 may also be linked by the utensil factory, the slaughterhouse or the user. The information may be linked by the factory before going to the slaughterhouse, when the slaughterhouse receives the utensil for the first time, through the user at the beginning of the shift or when the user arrives at some reading device 210, 220, 230, 240, 250, 260, 270, 280, preferably the workstation 270.

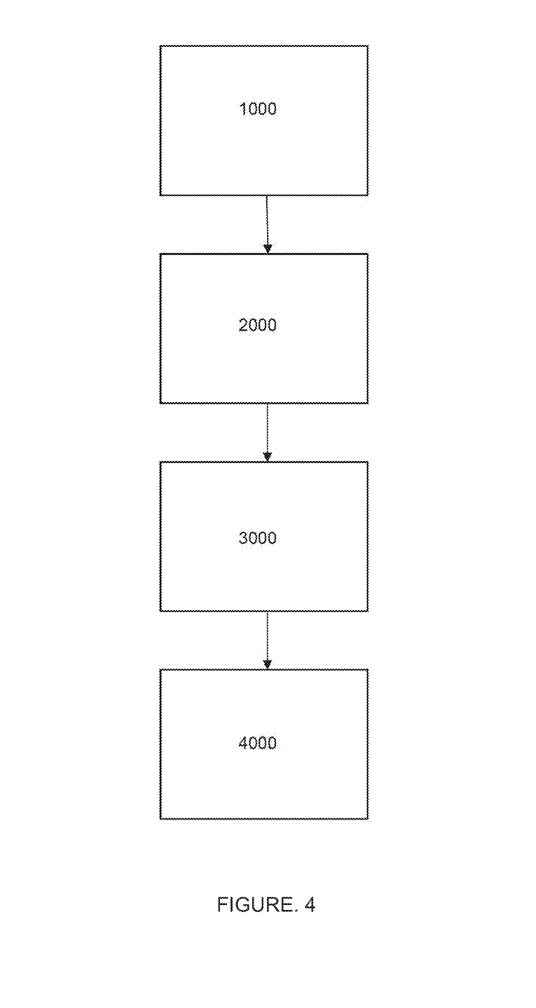

In FIG. 4, there is shown a block diagram of the steps of the method for monitoring utensils in slaughterhouses using the system and utensil of the present invention.

In step 1000, at least one data relating to at least one utensil 100 is collected through at least one reading device 210, 220, 230, 240, 250, 260, 270, 280; in step 2000, the data collected on at least one of a hardware and a cloud database is stored; and in step 3000 the data is available for query and monitoring of the at least one utensil 100.

The method may further comprise a step of: emitting 4000 at least one of an audible alert and a visual alert in at least one of the situations: when the reading means of a passage warning device 250 identifies a utensil 100 that should not move through the passage warning device 250 and when the workstation device 270 identifies that the utensil needs at least one of the maintenance of: sharpening, sanitizing and blade realignment when a certain time of the last maintenance has elapsed.

To assist in the utensil monitoring method, at least one of the following additional data is entered into the system: blade design, steel type, handle type, user performed activity.

The present invention provides a system and method of monitoring utensils and utensils that can collect multiple data from a slaughterhouse both related to the work of utensil users and the physical aspects of the utensil itself in order to create a database that can be studied both by the slaughterhouse and by the utensil factory, allowing both the slaughterhouse and the utensil factory to improve their products, services and quality, as well as to provide data to control the functional well-being of the utensil user and to avoid undesirable transit of utensils in and out of the slaughterhouse rooms.

Over time, new data reading devices (not mentioned herein) or utensils may appear, in which influence user satisfaction, utensil conditions and maintenance, and which may be included in the system of the present invention.

The embodiment example described above represents a preferred embodiment; however, it should be understood that the scope of the present invention encompasses other possible variations, and is limited only by the content of the appended claims, which include all possible equivalents.

1. A system for monitoring utensils (100) in slaughterhouses, comprising:
at least one utensil (100) comprising at least one readable medium (110) identifying the at least one utensil (100);
at least one reading device (210, 220, 230, 240, 250, 260, 270, 280) in at least one specific location of the slaughterhouse, reading the at least one readable medium (110) of the at least one utensil (100) for collecting at least one data relative to said utensil (100);
characterized in that the data collected by the reading device (210, 220, 230, 240, 250, 260, 270, 280) is stored in at least one of a hardware and a cloud database.

2. The system for monitoring utensils in slaughterhouses according to claim 1, characterized in that the data stored is shareable with at least one among all slaughterhouse plants and the utensil factory.

3. The system for monitoring utensils in slaughterhouses according to claim 1, characterized in that the at least one utensil (100) is at least one of: a knife, preferably for deboning, a protective glove, a meat separating aid device, an apron, a cap, a blade realignment device, a retainer device for pieces of meat, a user identification bracelet, individual protective equipment and an individual storage device.

4. The system for monitoring utensils in slaughterhouses according to claim 1, characterized in that the at least one readable medium (110) is at least one of: a bar code, a numerical code, a radiofrequency device, a Bluetooth device, an infrared device and QRCOD.

5. The system for monitoring utensils in slaughterhouses according to claim 1, characterized in that the at least one reading device (210, 220, 230, 240, 250, 260, 270, 280) is at least one of: a sharpening device (210), a sanitizing and sterilizing device (220), a chopping aid and support device (230), a disposal device (240), a passage warning device (250), a storage (260), a workstation device (270) and a blade realignment device (280).

6. The system for monitoring utensils in slaughterhouses according to claim 5, characterized in that the sharpening device (210) comprises: sharpening means, which sharpen the utensil and reading means, that reads the at least one readable medium (110) while the utensil is within the reach of the reading means.

7. The system for monitoring utensils in slaughterhouses according to claim 6, characterized in that the reading means of the sharpening device (210) collects at least one of the data: identification of the utensil (100), start time and date of sharpening, end time and date of sharpening, time of sharpening, inclination angle of sharpening, pressure against the abrasive, types of abrasive, adjustment of the abrasive positions, number of sharpenings and sharpening evaluation.

8. The system for monitoring utensils in slaughterhouse according to claim 5, characterized in that the sanitizing and sterilizing device (220) comprises: sanitizing means, which sanitize the utensil (100), sterilizing means, which sterilize the utensil (100) and reading means that reads the at least one readable medium (110) while the utensil is within the reach of the reading means.

9. The system for monitoring utensils in slaughterhouse according to claim 8, characterized in that the reading means of the sanitizing and sterilizing device (220) collects at least one of the data: identification of the utensil (100), start time and date of sanitizing, time of sanitizing, sanitizing temperature, start time and date of sterilizing, sterilizing time and sterilizing temperature.

10. The system for monitoring utensils in slaughterhouses according to claim 8 or 9, characterized in that the sanitizing and sterilizing device (220) separately comprises a sanitizing device and a sterilizing device, each device collecting its respective data.

11. The system for monitoring utensils in slaughterhouses according to claim 5, characterized in that the chopping aid and support device (230) comprises: chopping support means, which minimizes the loss of sharpness of the utensil (100) when both come into contact and reading means that reads the at least one readable medium (110) while the utensil (100) is within the reach of the reading means.

12. The system for monitoring utensils in slaughterhouses according to claim 11, characterized in that the reading means of the chopping aid and support device (230) collects at least one of the data: identification of the utensil (100), start date and time of reading, pressure against chopping aid and support (230), number of times the utensil comes into contact with chopping aid and support device (230), contact total time of the utensil (100) with the chopping aid and support device (230) and position of the utensil (100), wherein the position of the utensil (100) helps to identify the function of a utensil (100) user at that workstation.

13. The system for monitoring utensils in slaughterhouses according to claim 5, characterized in that the disposal device (240) comprises: user communication means (241), utensil disposal means (242) and reading means (243) that reads the at least one readable medium (110) while the utensil (100) is within the range of the reading means (243), wherein to discard the utensil (100), the user must inform the reason through the communication means (241), and if discard is approved, the discarding means (242) enables discarding of the utensil (100), wherein the discarding device (240) provides the user, through the user communication means (241): query of the history of utensil use, query of the quantity of utensils discarded and listing of discarded utensils.

14. The system for monitoring utensils in slaughterhouses according to claim 13, characterized in that the reading means (243) of the disposal device (240) collects at least one of the data: identification of the utensil (100) and time and date of disposal.

15. The system for monitoring utensils in slaughterhouses according to claim 13, characterized in that the user communication means (241) of the disposal device (240) enables the user to provide at least one of: sharpening evaluation of the utensil (100), reason for utensil disposal, user's admission dates in the slaughterhouse and user's training dates.

16. The system for monitoring utensils in slaughterhouses according to claim 5, characterized in that the passage warning device (250) comprises: an alert device and reading means, that reads the at least one readable medium (110) while the utensil (100) is within the reach of the reading means, the warning device emitting at least one of an audible alert and a visual alert when the reading means identifies a utensil (100) which should not move through the passage warning device (250).

17. The system for monitoring utensils in slaughterhouses according to claim 16, characterized in that the reading means of the passage warning device (250) collects at least one of the data: identification of the utensil (100) and time and date of the passage of the utensil (100).

18. The system for monitoring utensils in slaughterhouses according to claim 16 or 17, characterized in that the passage warning device (250) is located in pass-through aperture, in which the utensil (100) is displaceable through the device (250), the pass-through apertures being at least one of: passage doors between the rooms of the slaughterhouse, utensil (100) delivery windows, windows of the slaughterhouse itself or entrances to the slaughterhouse.

19. The system for monitoring utensils in slaughterhouses according to claim 5, characterized in that the workstation device (270) comprises reading means that reads the at least one readable medium (110) while the utensil (100) is in the range of the reading means, the workstation device (270) being located at the position where a user of the utensil (100) effectively performs its task, wherein the workstation device (270) notifies the user that the utensil needs at least one of the maintenance of: sharpening, sanitizing and blade realignment, when a certain time of the last maintenance has elapsed.

20. The system for monitoring utensils in slaughterhouses according to claim 21, characterized in that the reading means of the workstation device (270) collects at least one of the data: utensil (100) identification, reading start time and date, dwell time of utensil (100) at the workstation and position of utensil (100), wherein the position of the utensil (100) assists in identifying the function of a user of the utensil (100) at that workstation.

21. The system for monitoring utensils in slaughterhouses according to claim 5, characterized in that the storage (260) comprises: a place suitable for storing the utensils (100) and reading means that reads the at least one readable medium (110) while the utensil (100) is within the reach of the reading means.

22. The system for monitoring utensils in slaughterhouses according to claim 21, characterized in that the storage means (260) collects at least one of the data: identification of the utensil (100) and time and date of storage entry or exit.

23. The system for monitoring utensils in slaughterhouses according to claim 5, characterized in that the blade realignment device (280) comprises: blade realignment means and reading means that reads the at least one readable medium (110) while the utensil (100) is within the reach of the reading means.

24. The system for monitoring utensils in slaughterhouses according to claim 23, characterized in that the reading means of the blade realignment device (280) collects at least one of the data: identification of the utensil (100), time and date of the realignment, number of times the device was realigned, and total realign time.

25. The system for monitoring utensils in slaughterhouses according to any one of claims 1 and 5 to 24, characterized in that the at least one reading device (210, 220, 230, 240, 250, 260, 270, 280) comprises at least one of: data insertion means and user communication means, wherein the user performs an access for the insertion of data through a login and password in the user communication means.

26. The system for monitoring utensils in slaughterhouses according to any one of claims 1 and 5 to 25, characterized in that the data collected from the at least one reading device (210, 220, 230, 240, 250, 260, 270, 280) may be stored in at least one of: a hardware of each reading device (210, 220, 230, 240, 250, 260, 270, 280), a central hardware, which is interconnected between each of the at least one reading device (210, 220, 230, 240, 250, 260, 270, 280), and directly to a cloud, wherein the data stored in a cloud is sent through at least one of: directly through the reading devices (210, 220, 230, 240, 250, 260, 270, 280), and through a central delivery device, which receives data from the at least one reading device (210, 220, 230, 240, 250, 260, 270, 280) and sends said data to a cloud storage.

27. The system for monitoring utensils in slaughterhouses according to any one of claims 1 to 26, characterized in that the additional data relating to the slaughterhouse information are inserted into the system, the data being at least one of: the gender of the utensil (100) user, the type of task that the utensil (100) develops in the slaughterhouse, the type of meat to be deboned and the area of operation of the utensil (100).

28. The system for monitoring utensils in slaughterhouses according to any one of claims 1 to 27, characterized in that the data relating to the information of the slaughterhouse are linked to the utensils (100) by at least one of: the slaughterhouse itself, when receiving the utensils (100), the utensil factory and the user, wherein the user links the information in at least one of the periods: when he receives the utensil (100) for the first time at the beginning of his work shift and when it arrives at any reading device (210, 220, 230, 240, 250, 260, 270, 280), preferably the workstation (270).

29. The system for monitoring utensils in slaughterhouses according to any one of claims 1 to 28, characterized in that the data collected from the utensil (100) is inserted into the system, the data being at least one of: blade design, steel type, handle type, user-executed activity and data collected by the reading devices (210, 220, 230, 240, 250, 260, 270, 280).

30. Utensil (100), characterized by comprising: at least one readable medium (110) that identifies the at least one utensil (100) for monitoring in a system according to any one of claims 1 to 29, wherein the at least one readable medium (110) is preferably a radiofrequency device that is inserted into the interior of the utensil.

31. A method for monitoring utensils in slaughterhouses using a system according to any one of claims 1 to 29, characterized by comprising the steps of:
collecting (1000) at least one data relating to at least one utensil (100) according to claim 30, through at least one reading device (210, 220, 230, 240, 250, 260, 270, 280);
storing (2000) the data collected on at least one of a hardware and a cloud database; and
providing (3000) the data for query and monitoring of the at least one utensil (100).

32. The method for monitoring utensils in slaughterhouses according to claim 31, characterized by further comprising:
emitting (4000) at least one of an audible alert and a visual alert in at least one of the situations: when reading means of a passage warning device (250) identifies an utensil (100) which should not move through the passage warning device (250) and when the workstation device (270) identifies that the utensil needs at least one of the maintenance of: sharpening, sanitizing and realignment, when a certain time from the last maintenance has elapsed.

33. The method for monitoring utensils in slaughterhouses according to claim 31 or 32, characterized in that at least one of additional data is inserted to aid in monitoring: blade design, steel type, handle type, user-executed activity.
